(19) United States
(12) Patent Application Publication
(10) Pub. No.: US 2014/0097159 A1
(43) Pub. Date: Apr. 10, 2014

(54) SYSTEM AND METHOD FOR BRAZING TSP MATERIALS TO SUBSTRATES

(71) Applicant: SMITH INTERNATIONAL, INC., HOUSTON, TX (US)

(72) Inventors: J. DANIEL BELNAP, LINDON, UT (US); MADAPUSI KESHAVAN, THE WOODLANDS, TX (US)

(73) Assignee: SMITH INTERNATIONAL, INC., HOUSTON, TX (US)

(21) Appl. No.: 13/837,416

(22) Filed: Mar. 15, 2013

Related U.S. Application Data
(60) Provisional application No. 61/709,433, filed on Oct. 4, 2012.

(51) Int. Cl. B23K 1/00

(52) U.S. Cl. CPC B23K 1/0008
USPC 219/85.22

(57) ABSTRACT

Methods and systems of attaching a thermally stable polycrystalline diamond (TSP) material layer to a substrate. The methods include placing a braze material between the TSP material layer and the substrate, pressing at least one of the TSP material layer and substrate against the other of the TSP material layer and the substrate, heating the braze material to a temperature of at least 800° C., and cooling the braze forming a bond attaching the TSP material layer to the substrate.

### CROSS-REFERENCE TO RELATED APPLICATION(S)

This application claims the benefit of U.S. Provisional Patent Application Ser. No. 61/709433 filed Oct. 4, 2012, which is incorporated herein by reference in its entirety.

### BACKGROUND

Ultra-hard materials are often used in cutting tools and rock drilling tools. Polycrystalline diamond (PCD) material is one such ultra-hard material, and is known for its good wear resistance and hardness. To form polycrystalline diamond, diamond particles are sintered at high pressure and high temperature (HPHT sintering) at a pressure of 5 to 10 GPa and a temperature of 1350° C. to 1500° C., to produce an ultra-hard polycrystalline structure. A catalyst material is added to the diamond particle mixture prior to sintering and/or infiltrates the diamond particle mixture during sintering in order to promote the intergrowth of the diamond crystals during HPHT sintering, to form the polycrystalline diamond structure. Metals conventionally employed as the catalyst are selected from the group of solvent metal catalysts selected from Group VIII of the Periodic table, including cobalt, iron, and nickel, and combinations and alloys thereof. After HPHT sintering, the resulting PCD structure includes a network of interconnected diamond crystals or grains bonded to each other, with the catalyst material occupying the interstitial spaces or pores between the bonded diamond crystals. The diamond particle mixture may be HPHT sintered in the presence of a substrate, to form a PCD compact bonded to the substrate. The substrate may also act as a source of the metal catalyst that infiltrates into the diamond particle mixture during sintering.

Conventional PCD bodies may be vulnerable to thermal degradation when exposed to elevated temperatures during cutting and/or wear applications. This vulnerability results from the differential that exists between the thermal expansion characteristics of the metal catalyst disposed interstitially within the PCD body and the thermal expansion characteristics of the intercrystalline bonded diamond. This differential thermal expansion is known to start at temperatures as low as 400° C., and can induce thermal stresses that are detrimental to the intercrystalline bonding of diamond and that eventually result in the formation of cracks that can make the PCD structure vulnerable to failure. Accordingly, such behavior is not desirable.

Another form of thermal degradation known to exist with conventional PCD materials is one that is also related to the presence of the metal catalyst in the interstitial regions of the PCD body and the adherence of the metal catalyst to the diamond crystals. Specifically, the metal catalyst is known to cause an undesired catalyzed phase transformation in diamond (converting it to carbon monoxide, carbon dioxide, or graphite) with increasing temperature, thereby limiting the temperatures at which the PCD body may be used.

To improve the thermal stability of the PCD material, the catalyst material may be removed from the PCD body after sintering, to form thermally stable PCD. This thermally stable PCD material (referred to as “TSP”) is formed by first HPHT sintering diamond particles in the presence of a metal catalyst, forming a PCD body with the catalyst occupying the interstitial regions between the diamond crystals. Then, the catalyst material is removed from the PCD body, leaving a network of empty interstitial spaces between the diamond crystals. For example, one known approach is to remove a substantial portion of the catalyst material from at least a portion of the sintered PCD by subjecting the sintered PCD construction to an acid leaching process, such as that disclosed for example in U.S. Pat. No. 4,224,380. Applying the leaching process to the PCD results in a thermally stable material portion substantially free of the catalyst material. If a substrate was used during the HPHT sintering, it is often removed from the PCD body prior to leaching. As used herein, the term “substantially free” when used in referring to amount of binder or catalyst material in the polycrystalline ultra-hard body is understood to mean that the catalyst material can actually be removed from a desired region thereof or the entire body, or that the catalyst material remains in the region or the entire body but has been reacted or otherwise treated so that it no longer functions in a catalytic function with respect to the surrounding polycrystalline phase, or that none at all or only trace amounts of the binder or catalyst material remains in the region or the entire body. The catalyst material may also be removed by other suitable processes such as by chemical treatment such as by acid leaching or aqua regia bath, electrochemically such as by electrolytic process, by liquid metal solubility, or by liquid metal infiltration that sweeps the existing catalyst material away and replaces it with another noncatalyst material during a liquid phase sintering process, or by combinations thereof

As another way to improve the thermal stability of the PCD material, a carbonate catalyst has been used to form the PCD. Such PCD is commonly referred to as “carbonate PCD”. The carbonate catalyst is mixed with the diamond powder prior to sintering, and promotes the growth of diamond grains during sintering. When a carbonate catalyst is used, the diamond remains stable in polycrystalline diamond form with increasing temperature, rather than being converted to carbon dioxide, carbon monoxide or graphite. Thus the carbonate PCD is more thermally stable than PCD formed with a metal catalyst and as such is also deemed to be TSP.

As another way to provide a more thermally stable ultra-hard diamond, diamond bodies with high diamond content have been provided, by reducing the amount of catalyst material. Additionally, binderless polycrystalline diamond has been formed, without the use of a catalyst material. The resulting diamond material has a uniform intercrystalline diamond microstructure, without catalyst material interspersed between the diamond crystals. As a result, the binderless diamond body does not suffer from differential thermal expansion between diamond and catalyst. Binderless diamond is also deemed to be TSP.

TSP material may also be formed by forming polycrystalline diamond with a thermally compatible silicon carbide binder instead of cobalt. “TSP” as used herein refers to any of the aforementioned types of TSP materials.

One way of attaching TSP to a substrate (as for example, a tungsten carbide substrate) is with the use of a braze material forming a braze bond between the TSP material layer and the substrate. In other words, a layer of a braze material is used to attach a TSP material layer to a substrate forming a cutting element or compact. Braze layers in such compacts tend to be porous, sometimes greater than 1% by volume and sometimes even greater than 4% by volume, resulting in a premature or an earlier failure of the braze bond.

### SUMMARY

In an embodiment, a method of attaching a thermally stable polycrystalline diamond (TSP) material layer to a substrate is provided. The method includes placing a braze material between the TSP material layer and the substrate, pressing at least one of the TSP material layer and substrate against the other of the TSP material layer and the substrate, heating the braze material to a temperature of at least 800° C., and cooling the braze forming a bond attaching the TSP material layer to the substrate. In one embodiment, placing includes placing a braze material between the TSP material layer and the substrate forming an assembly and heating includes heating the assembly within a furnace chamber. In another embodiment, the method further includes exposing the assembly to gas, such as hydrogen based gases, nitrogen based gases, argon based gases, inert gases and combinations thereof. In a further embodiment, the method also includes drawing a vacuum through the chamber after exposing and prior to heating. In one embodiment, heating includes induction heating. In another embodiment, the method further includes surrounding at least a portion of the assembly with induction coil for induction heating the braze. In yet another embodiment, the method also includes placing a heat sink on the TSP material layer prior to heating. In an embodiment, this is done prior to pressing. In further embodiment, pressing includes pressing the assembly at a pressure of at least 1000 psi, while in another embodiment, pressing includes pressing the assembly at a pressure in the range of 1000 psi to 15000 psi. In another embodiment, the cooled braze has a porosity of 0.1% or less by volume. In a further embodiment, the cooled braze has a porosity of 0.5% or less by volume.

In a further embodiment a brazing system for brazing a thermally stable polycrystalline diamond (TSP) material layer to a substrate is provided. The system includes a first member for supporting an assembly of the TSP material layer, the braze material and the substrate, with the braze material between the TSP material layer and the substrate, and a second member. At least one of the first and second members is movable toward the other of the first and second members for applying a pressure against the assembly. The system also includes a furnace chamber and the first and second members are at least partially within the chamber. The system further includes a vacuum source for drawing a vacuum in the furnace chamber, a first seal between the first member and the furnace chamber, and a second seal between the second member and the furnace chamber. In another embodiment, the system also includes an inert gas source for providing an inert gas to the vacuum chamber.

In a further embodiment, another brazing system for brazing a thermally stable polycrystalline diamond (TSP) material layer to a substrate is provided. This system includes a first member for supporting an assembly of the TSP material layer, the braze material and the substrate with the braze material between the TSP material layer and the substrate, and a second member. At least one of the first and second members is movable toward the other of the first and second members for applying a pressure against the assembly. The system further includes n induction coil for surrounding the assembly, and a heat sink adjacent the second member. In another embodiment, the heat sink is adjacent to the second member for interfacing with the TSP material layer. In yet another embodiment the system further includes an inert gas source for providing an inert gas to the assembly.

This summary is provided to introduce a selection of concepts that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

FIG. 1 is a perspective view of an assembly of a TSP material, braze and substrate prior processing according to a method of the present disclosure.

FIG. 2 is a perspective view of a compact formed from the assembly shown in FIG. 1 after processing according to a method of the present disclosure.

FIG. 3 is a schematic view of a brazing system according to an embodiment of the present disclosure.

FIG. 4 is a schematic view of a brazing system according to another embodiment of the present disclosure.

FIG. 5 depicts a flow chart of a method according to an embodiment of the present disclosure.

### DETAILED DESCRIPTION

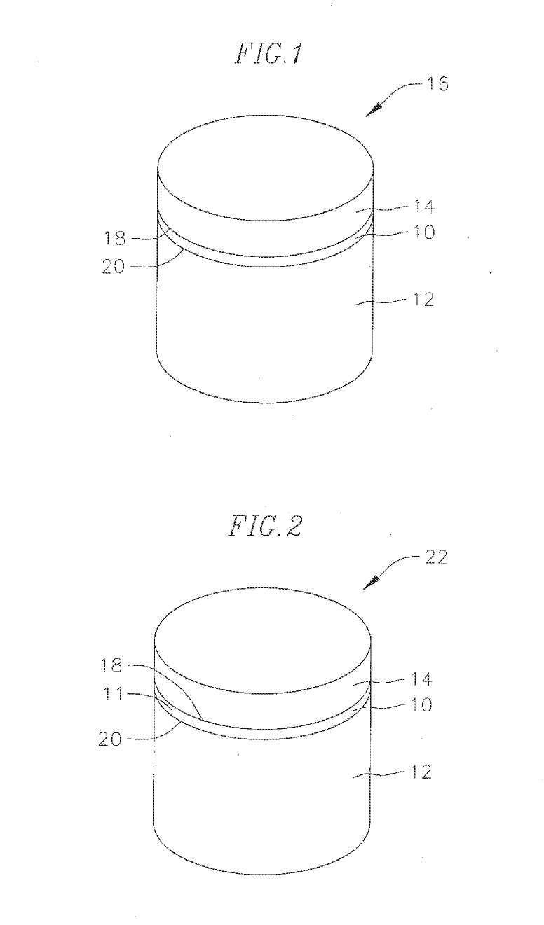

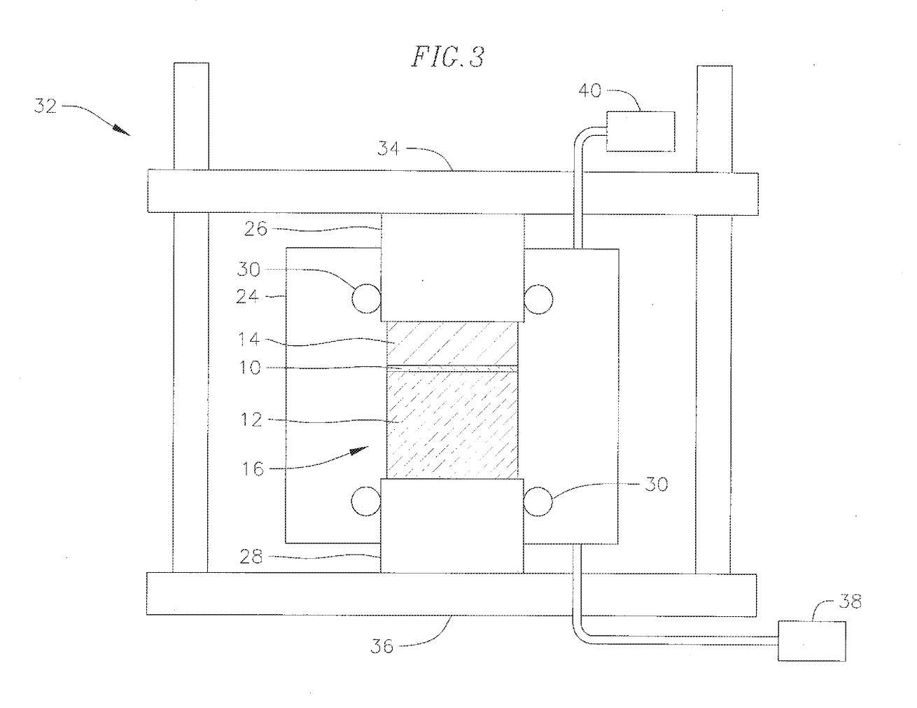

In one embodiment, a braze material 10 is applied between a substrate 12 and a TSP material layer 14 to form an assembly 16, as shown in FIG. 1. In an embodiment, the TSP material layer has an interface surface 18 and the substrate has an interface surface 20 for interfacing with the interface surface 18 of the TSP material layer. The braze material is used to attach the TSP material layer to the substrate to form a compact 22 as described herein and shown in FIG. 2 The brazing material may be applied to one or both interface surfaces. The braze material may be copper and may include one or more active elements such as titanium or silicon. Other well-known brazing materials may also be used. For example, braze materials useful for forming TSP compacts 22 of this disclosure include those selected from the group including Ag, Au, Cu, Ni, Pd, B, Cr, Si Ti, Mo, V, Fe, Al, Mn, Co, and mixtures and alloys thereof. Alloys including two or more of the above-identified materials are especially desired and useful for this purpose. Brazing materials useful for attaching the TSP material layer 14 to the substrate 12 include those characterized as being “active” and “nonactive.” “Active” braze materials are those that react with the TSP material, and for this reason are used for attaching the TSP material layer of the compact to the substrate, while “nonactive” braze materials are those that do not necessarily react with the TSP material. Nonactive braze materials may also be used with this disclosure.

Example “active” braze materials useful for attaching a TSP material layer to a substrate of this disclosure include, but are not limited to, those having the following composition and liquidus temperature (LT) and solidus temperatures (ST), where the composition amounts are provided in the form of weight percentages:

### 81.25 Au, 18 Ni, 0.75 Ti, LT=960° C., ST=945° C.;

### 82 Au, 16 Ni, 0.75 Mo, 1.25 V LT=960° C., ST=940° C.;

### 20.5 Au, 66.5 Ni, 2.1 B, 5.5 Cr, 3.2 Si, 2.2 Fe, LT=971° C., 5T941° C.;

### 56.55 Ni, 30.5 Pd, 2.45 B, 10.5 Cr, LT=977° C., ST=941° C.;

### 92.75 Cu, 3 Si, 2 Al, 2.25 Ti, LT=1,024° C., ST=969° C.;

### 82.3 Ni, 3.2 B, 7 Cr, 4.5 Si, 3 Fe, LT=1,024° C.; ST=969° C.; and

### 96.4 Au, 3 Ni, 0.6 Ti, LT=1,030° C., ST=1,003° C.

Example “nonactive” braze materials that may be used for attaching TSP material to a substrate of this disclosure include those having the following composition and liquid temperature (LT) and solid temperature (ST), where the composition amounts are provided in the form of weight percentages:

### 52.5 Cu, 9.5 Ni, 38 Mn, LT=925° C., ST=880° C.;

### 31 Au, 43.5 Cu, 9.75 Ni, 9.75 Pd, 16 Mn, LT=949° C., ST=927° C.;

### 54 Ag, 21 Cu, 25 Pd, LT=950° C., ST=900° C.;

### 67.5 Cu, 9 Ni, 23.5 Mn, LT=955° C., ST=925° C.;

### 58.5 Cu, 10 Co, 31.5 Mn, LT=999° C., ST=896° C.;

### 35 Au, 31.5 Cu, 14 Ni, 10 Pd, 9.5 Mn, LT=1,004° C., ST=971° C.;

### 25 Su, 37 Cu, 10 Ni, 15 Pd, 13 Mn, LT=1,013° C., ST=970° C.; and

### 35 Au, 62 Cu, 3 Ni, LT=1,030° C., ST=1,000° C.

As noted above, braze materials useful for attaching TSP material to a substrate can be active and react with the TSP material used to form the compact. In an example embodiment, where such an active braze material is used, the braze material can react with the TSP material to form a reaction product therein and/or between it and the adjacent substrate. The presence of such reaction product can operate to enhance the thermal and/or mechanical properties of the TSP material. For example, where the braze material includes silicon or titanium and the TSP material includes a polycrystalline diamond ultra-hard phase, the silicon or titanium in the braze material reacts with the carbon in the diamond to form SiC or TiC.

In addition to the properties of being active or nonactive, braze materials used to attached a TSP material to a substrate of this disclosure can be selected based on their characteristic liquid (liquidus) or solid/crystallization (solidus) temperatures. Additionally, when compacts of this disclosure are to be attached to an end-use application device by welding or brazing technique, it is also desired that the braze material selected be one having a liquidus temperature that is higher than the welding or brazing temperature used to attach the compact to the end-use device. For example, where the compact is provided in the form of a cutting element for attachment on a bit for drilling subterranean formations, it is desired that the braze material have a liquidus/solidus temperature that is above that used to join the compact to such drill bit.

The assembly 16 is placed in a vacuum furnace chamber 24, as shown in FIG. 3. In an embodiment, the furnace includes two supports 26, 28. The substrate and/or the TSP material layer are rested on one support within the furnace chamber, as for example support 28 shown in FIG. 3. One or both of the supports are movable, towards each other for exerting a pressure against the TSP material layer, the braze layer, and the substrate. A seal 30 is provided between each support and the vacuum furnace chamber to ensure that vacuum, when applied to the vacuum furnace chamber, is not leaked as one or both supports move towards each other. A structure, such as a frame 32 having opposite loading members 34, 36 one or both of which move towards each other, may be used for moving one or both supports towards the other for generating pressure against the assembly 16. The loading members may move towards each other using hydraulic, electrical or mechanical devices known in the art. For example, the load applying members may be threadedly or slideably engaged to the frame and moved toward each using mechanical, electrical or hydraulic devices known in the art. In another embodiment, the supports may entirely reside within the vacuum furnace chamber.

Hydrogen, nitrogen, or argon based gas, or another inert gas or combinations thereof is pumped into the vacuum furnace chamber from a source 38 to clean metallic surfaces and to remove any oxygen. A vacuum is then drawn by a vacuum source 40 through the vacuum furnace chamber removing the hydrogen, nitrogen, or argon based gas, or other inert gas, or combinations thereof and any impurities removed from the metallic surfaces as well as the oxygen. In an embodiment, a vacuum pressure of about 1×10⁻³ Torr is sufficient, which can be supplied by a single stage vacuum system. In other embodiments, a vacuum pressure in the range of 1×10⁻³ to 1×10⁻⁷ Torr is used, which may be supplied by a multistage vacuum system. Such vacuum systems are known in the art. A pressure is then applied to the assembly 16 by moving one or both supports towards each other. A pressure in the range of 5 psi to 15,000 psi is applied to the assembly by the supports while the vacuum furnace chamber is heated to a temperature sufficient for heating the braze to a temperature in the range of 800° to 1200° C. In one embodiment, the pressure applied is in the range of 1000 psi to 15,000 psi. In another embodiment, the pressure applied is in the range of 5 psi to 1,000 psi. In one embodiment, the vacuum furnace chamber is heated to a temperature for heating the braze to a temperature greater than 920° C. and in another embodiment for heating the braze to a temperature greater than 1050° C. Temperatures above about 1050° C. are higher than the temperature used in brazing conventional PCD material to a substrate. When brazing conventional PCD to a substrate, the braze may be heated to a temperature lower than 920° C. to minimize graphitization of the PCD material. The temperature to which the braze is heated in the present disclosure is also dependant on the type of braze, and more specifically to the liquidus temperature of the braze, i.e., the temperature at which the braze liquefies. This temperature in an embodiment is maintained for a period of time in the range of about 30 seconds to 120 seconds. With higher temperatures, lower times may be used to minimize graphitization of the TSP material. The pressure provided by the support members is maintained while the braze is in a liquidus state. The assembly 16 of the TSP material layer with braze and substrate is then allowed to cool and solidify, whereby the braze bonds the TSP material layers to the substrate forming a compact 22 having a braze layer 11 having little or no porosity. In an embodiment, the porosity is 0.1% by volume or lower. In another embodiment, the porosity is 0.5% by volume or lower. In an embodiment, the pressure is relieved once the braze is cooled to a temperature below is liquidus temperature, i.e., cooled to a temperature where the braze solidifies and bonds the TSP material to the substrate.

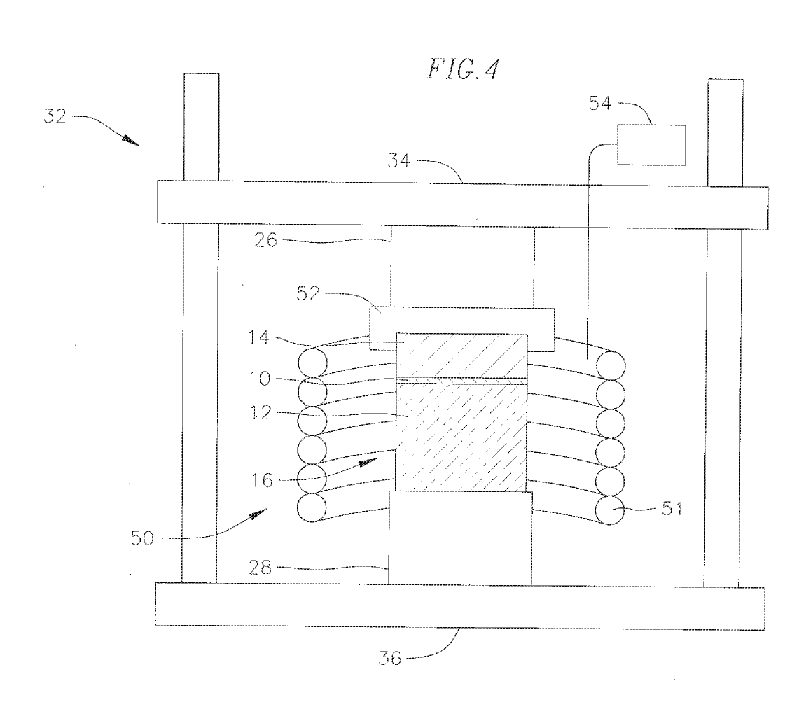

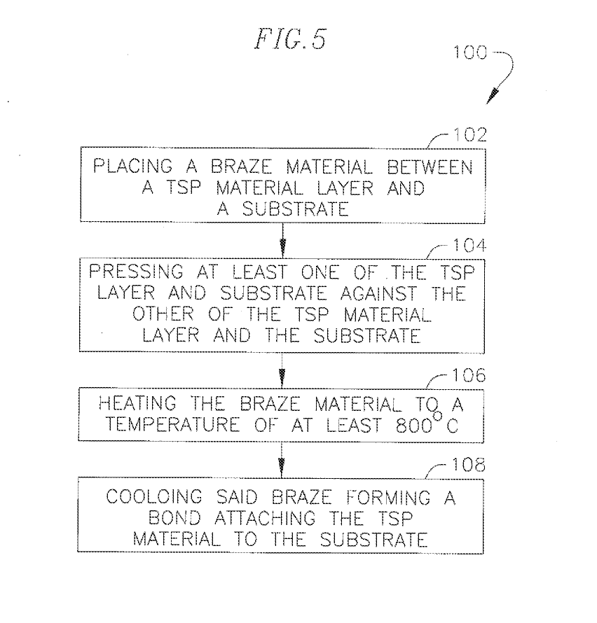

In another embodiment, instead of a vacuum furnace chamber, an induction heating system 50 is used, as for example shown in FIG. 4. The assembly 22 is placed on one of the supports, as for example support 28 shown in FIG. 4. As with the previous embodiment, the supports are coupled to a frame 32 and loading members 34, 36 for moving one support towards the other or for moving both towards each other for generating a pressure against the assembly. With this embodiment, an induction coil 51 surrounds the assembly. A heat sink 52 is placed over the TSP material layer 14 and between the supports 26, 28. In the example embodiment shown in FIG. 4, the heat sink is placed between the TSP layer and the support 26. The heat sink is an embodiment is a solid layer of material such as copper or other ceramic such as an aluminum nitrite. Prior to brazing, a gas such as nitrogen, hydrogen or argon based gas, or other inert gas or a combination thereof, may be fed from a source 54 under pressure over the assembly. The gas for example may be fed via a nozzle. The gas flushes out the oxygen and may help to remove some of the impurities from the metallic surfaces. The supports are then moved toward each other to generate a pressure. In one embodiment, pressure in the range of 5 psi to 15,000 psi is generated. In another embodiment, the pressure applied is in the range of 1000 psi to 15,000 psi. In a further embodiment, the pressure applied is in the range of 5 psi to 1,000 psi. Power is then supplied to the induction coil for induction heating the assembly 22. Power, such as electrical power, is supplied to the induction coil causing the coil to heat the assembly 22 to a temperature sufficient for heating the braze to a temperature in the range of 800° C. to 1200° C. In one embodiment, the temperature is sufficient for heating the braze to a temperature greater than 920° C. and in another embodiment for heating the braze to a temperature greater than 1050° C. The heating temperature is dependent on the type of braze and the liquidus temperature of the braze, i.e., the temperature at which the braze liquefies. Induction heating is generally very fast in that the induction coils generate high heat in a matter of seconds. For example, the desired heating temperature of the braze, e.g., a temperature in the range of 800° C. to 1200° C., of may be reached in about 30 seconds or less. The temperature in an embodiment is maintained for a time of about 5 seconds or less. The pressure is maintained while the braze is in a liquidus state. The assembly 16 of the TSP material layer with braze and substrate is then allowed to cool, whereby the braze solidifies and bonds the TSP material layer to the substrate forming a compact 22 having a braze layer 11 having little or no porosity. In an embodiment, the pressure is relieved once the braze is cooled to a temperature below is liquidus temperature, i.e., cooled to a temperature where the braze solidifies and bonds the TSP material to the substrate.

Because induction heating heats up very fast, it may be hard to control the temperature of the TSP material layer. The heat sink 52 is used to absorb some of the heat from the TSP material layer, thereby controlling the heating rate and temperature of the TSP material layer so as to prevent graphitization of the TSP material which may occur due to the rapid heating.

In another embodiment, a furnace chamber the induction coils may be within a furnace chamber similar to the vacuum, furnace chamber 24 shown in FIG. 3.

In an embodiment as shown in the flow chart 100 in FIG. 5, the braze material is placed between the TSP material layer and the substrate (102). At least one of the TSP material layer and substrate is the pressed against the other of the TSP material layer and the substrate (104). The braze material is heated to a temperature of at least 800° C. (106). The braze is then cooled forming a bond attaching the TSP material layer to the substrate (108).

Although only a few example embodiments have been described in detail above, those skilled in the art will readily appreciate that many modifications are possible in the example embodiments without materially departing from this disclosure. Accordingly, all such modifications are intended to be included within the scope of this disclosure as defined in the following claims. It is the express intention of the applicant not to invoke 35 U.S.C. 112, paragraph 6 for any limitations of any of the claims herein, except for those in which the claim expressly uses the words ‘means for’ together with an associated function.

What is claimed is:

1. A method of attaching a thermally stable polycrystalline diamond (TSP) material layer to a substrate comprising:
placing a braze material between the TSP material layer and the substrate;
pressing at least one of said TSP material layer and substrate against the other of said TSP material layer and the substrate;
heating said braze material to a temperature of at least 800° C.; and
cooling said braze forming a bond attaching said TSP material layer to said substrate.

2. The method as recited in claim 1, wherein placing comprises placing a braze material between the TSP material layer and the substrate forming an assembly and wherein heating comprises heating said assembly within a furnace chamber.

3. The method as recited in claim 2, further comprising exposing said assembly to gas selected from the group of gases consisting essentially of hydrogen based gases, nitrogen based gases, argon based gases, inert gases and combinations thereof

4. The method as recited in claim 3, further comprising drawing a vacuum through the chamber after exposing and prior to heating.

5. The method as recited in claim 1, wherein heating comprises heating said braze to a temperature greater than 920° C.

6. The method as recited in claim 1, wherein heating comprises heating said braze to a temperature greater than 1050° C.

7. The method as recited in claim 1, wherein heating comprises induction heating.

8. The method as recited in claim 1, further comprising surrounding at least a portion of the assembly with induction coil for induction heating said braze.

9. The method as recited in claim 8, further comprising placing a heat sink on said TSP material layer prior to heating.

10. The method as recited in claim 8, further comprising placing a heat sink on said TSP material layer prior to pressing.

11. The method as recited in claim 1, wherein pressing comprises pressing the assembly at a pressure of at least 1000 psi.

12. The method as recited in claim 1, wherein pressing comprises pressing the assembly at a pressure in the range of 1000 psi to 15000 psi.

13. The method as recited in claim 1, wherein pressing comprises pressing the assembly at a pressure in the range of 5 psi to 15,000 psi.

14. The method as recited in claim 1, wherein pressing comprises pressing the assembly at a pressure in the range of 5 psi to 1,000 psi.

15. The method as recited in claim 1, wherein, after cooling, the braze has a porosity not greater than 0.1% by volume.

16. The method as recited in claim 1, wherein, after cooling, the braze has a porosity not greater than 0.5% by volume.

17. A brazing system for brazing a thermally stable polycrystalline diamond (TSP) material layer to a substrate comprising:
a first member for supporting an assembly of the TSP material layer, the braze material and the substrate with the braze material between the TSP material layer and the substrate;
a second member, wherein at least one of the first and second members is movable toward the other of the first and second members for applying a pressure against the assembly;
a furnace chamber, wherein the first and second members are at least partially within said chamber;
a vacuum source for drawing a vacuum in said furnace chamber;
a first seal between the first member and the furnace chamber; and
a second seal between the second member and the furnace chamber.

18. The brazing system as recited in claim 17, further comprising an inert gas source for providing an inert gas to the vacuum chamber.

19. A brazing system for brazing a thermally stable polycrystalline diamond (TSP) material layer to a substrate comprising:
a first member for supporting an assembly of the TSP material layer, the braze material and the substrate with the braze material between the TSP material layer and the substrate;
a second member, wherein at least one of the first and second members is movable toward the other of the first and second members for applying a pressure against the assembly;
an induction coil for surrounding the assembly; and
a heat sink adjacent the second member.

20. The brazing system as recited in claim 19, further comprising an inert gas source for providing an inert gas to the assembly.
